(19) United States
(12) Patent Application Publication
(10) Pub. No.: US 2008/0043594 A1
(43) Pub. Date: Feb. 21, 2008

(54) Data transmission apparatus, data transmission method and recording medium

(75) Inventors: Takeshi Morikawa, Takarazuka-shi (JP); Nobuo Kamei, Amagasaki-shi (JP); Minako Kobayashi, Ikeda-shi (JP); Kei Shigehisa, Amagasaki-shi (JP); Masayuki Yoshii, Sakai-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/607,947

(22) Filed: Dec. 4, 2006

(30) Foreign Application Priority Data
Jul. 10, 2006 (JP) 2006-189844

(51) Int. Cl. G11B 3/74; G11B 7/20

(52) U.S. Cl. 369/93

(57) ABSTRACT

A data transmission apparatus, comprising: a recording unit for recording data output settings for respective users preliminarily; a communication unit for transmitting to a recipient user target data with the output setting either for a sender user or the recipient user, which is recorded in said recording unit, according to an instruction by the sender user; and a display unit for previewing at least one of output settings for the sender user and the recipient user among those recorded in said recording unit, before transmitting said data.

This application claims priority under 35 U.S.C. §119 to Japanese Patent Application No. 2006-189844 filed on Jul. 10, 2006, the entire disclosure of which is incorporated herein by reference in its entirety.

### BACKGROUND OF THE INVENTION

1. Field of the Invention

The present invention relates to a data transmission apparatus which is used by connecting to a network and is capable of transmitting data such as image data to a recipient user that is the destination, a data transmission method, and a recording medium recording a data transmission processing program to make a computer execute data transmission processing.

2. Description of the Related Art

The following description sets forth the inventor's knowledge of related art and problems therein and should not be construed as an admission of knowledge in the prior art.

In recent years, the system in which a plurality of image forming apparatuses, which are examples applied to data transmission apparatuses, are shared with a plurality of users by connecting to a network, has become widely used in companies and offices.

As for such a prevailing image forming apparatus, data output settings for respective users are preliminarily recorded in a recording unit thereof. And, when a sender user intends to transmit data such as image data to a recipient user from the image forming apparatus, the data will be usually transmitted with the output setting for the recipient user.

However, there is a case where the sender user prefers the recipient user to output data with the output setting for the sender user himself/herself, and in this case, the sender user needs to change the output setting. Therefore, the sender user bothers to check the output settings both for the recipient user and the sender user himself/herself whether or not those are the same.

Meanwhile, an art disclosed in the Japanese Unexamined Laid-open Patent Publication No. 2000-293346 is that image to be distributed can be previewed on a sender device. In the art, preview data is generated based on performance information of a destination output apparatus when an instruction to preview the image is given, and then image data suitable to the performance of the destination output apparatus is generated and distributed when distribution is requested.

In addition, another art disclosed in the Japanese Unexamined Laid-open Patent Publication No. 2001-67347 is that the successful printing results are achieved by previewing functions of and a print setting for a device.

In sum, in the conventional arts disclosed in the two patent publications, data is previewed based on performance information of a destination output apparatus, and functions of and a print setting for a device are previewed. Therefore, the arts still do not provide a solution to resolve the inconvenience that a sender user bothers to check data output settings both for a recipient user and the sender user himself/herself.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

An object of the present invention is to provide a data transmission apparatus allowing a sender user to check easily output settings for a recipient user or the sender user himself/herself when data is transmitted.

Another object of the present invention is to provide a data transmission method allowing a sender user to check easily output settings for a recipient user or the sender user himself/herself when data is transmitted.

Yet another object of the present invention is to provide a recording medium storing a data transmission processing program to make a computer execute data transmission processing.

A first aspect of the present invention is a data transmission apparatus, comprising:

a recording unit for recording data output settings for respective users preliminarily;

a communication unit for transmitting to a recipient user target data with the output setting either for a sender user or the recipient user, which is recorded in said recording unit, according to an instruction by the sender user; and

a display unit for previewing at least one of output settings for the sender user and the recipient user among those recorded in said recording unit, before transmitting said data.

A second aspect of the present invention is a data transmission method, comprising the steps of:

transmitting to a recipient user target data with the output setting either for a sender user or the recipient user, which is recorded in said recording unit, according to an instruction by the sender user; and

previewing at least one of output settings for the sender user and the recipient user among those recorded in said recording unit, before transmitting said data.

A third aspect of the present invention is a recording medium recording a data transmission processing program for making a computer execute the steps of:

transmitting to a recipient user target data with the output setting either for a sender user or the recipient user, which is recorded in said recording unit, according to an instruction by the sender user; and

previewing at least one of output settings for the sender user and the recipient user among those recorded in said recording unit, before transmitting said data.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a diagram showing a configuration of a file sharing system using an image forming apparatus as a data transmission apparatus according to an embodiment of the present invention;

FIG. 2 is an external view of the image forming apparatus;

FIG. 3 is a block diagram showing an electric configuration of the image forming apparatus;

FIG. 4 is a diagram showing an example of contents recorded in a hard disk;

FIG. 5 is a diagram showing an example of a specification of a file;

FIG. 6 is a diagram showing an example of a user information database;

FIG. 7 is a diagram showing a functional configuration of the image forming apparatus;

FIG. 8 is a flowchart showing the entire process executed in the image forming apparatus;

FIG. 9 is a diagram showing an example of an initial menu screen displayed on a display unit;

FIG. 10 is a diagram showing a screen for inputting a name of a file to be recorded;

FIG. 11 is a diagram showing a screen for selecting a box from which a file is to be read out;

FIG. 12 is a diagram showing a screen for inputting a name of a file to be read out;

FIG. 13 is a diagram showing a screen for selecting a box from which a file is to be forwarded;

FIG. 14 is a diagram showing a screen for inputting a name of a file to be forwarded;

FIG. 15 is a diagram showing a screen for selecting a recipient user as a transfer destination;

FIG. 16 is a diagram showing a screen for setting a target to be previewed;

FIG. 17 is a diagram showing an example of a preview screen;

FIG. 18 is a diagram showing another example of a preview screen; and

FIG. 19 is a flowchart showing a subroutine for a preview process.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

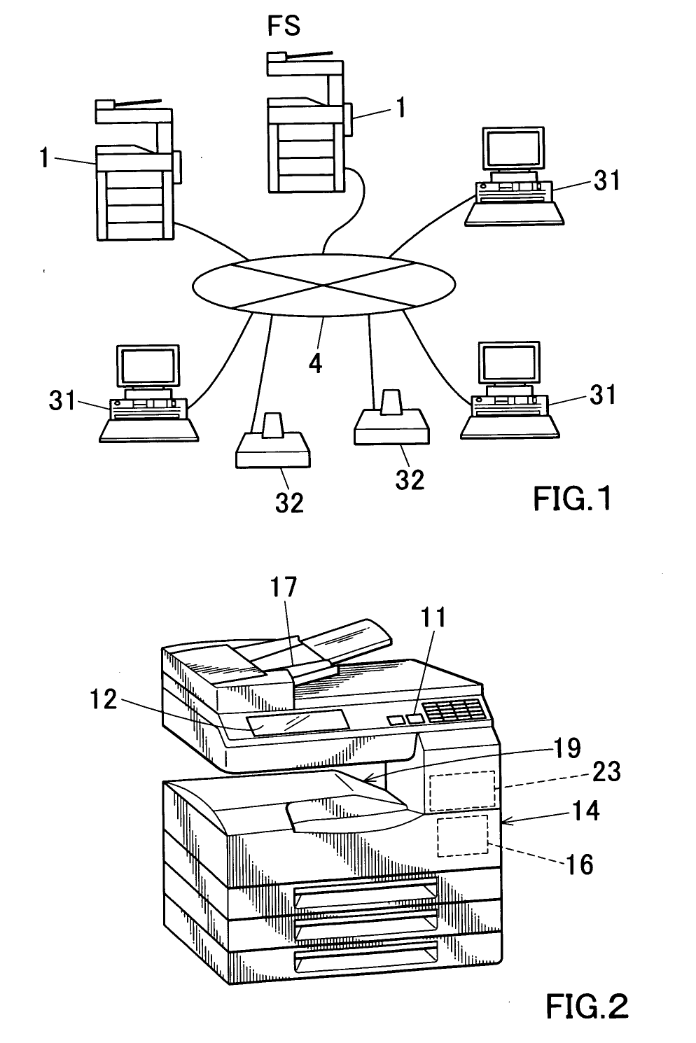

FIG. 1 is a diagram showing a configuration of a file sharing system using a data transmission apparatus according to an embodiment of the present invention.

As shown in FIG. 1, a file sharing system FS comprises, for example, a plurality of image forming apparatuses 1 as file transmission apparatuses, one or more personal computers (hereinafter, referred to as PCs) 31, and one or more facsimile apparatuses (hereinafter, referred to as FAX terminals) 32. And the image forming apparatuses 1, the PCs 31 and the FAX terminals 32 are network-connected via a communications line 4 for mutual communication.

To identify each of the image forming apparatuses 1 and the PCs 31, computer names, such as “PC001”, “PC002”, etc. are provided as identification information for them, respectively. Of course, IP addresses also may be used as identification information instead of such computer names above. On the other hand, phone numbers that are usually used for so-called fixed-line phones or IP phones are provided for the FAX terminals 32, respectively.

A LAN, the Internet, a dedicated line, a public line or etc. is used as the communications line 4. And, TCP/IP (Transmission Control Protocol/Internet Protocol), FTP (File Transfer Protocol), POP3 (Post Office Protocol version 3), SMTP (Simple Mail Transfer Protocol), IPP (Internet Printing Protocol), IEEE802.3 (a standard for wired LAN), IEEE802.11 (a standard for wireless LAN), G3 (Group 3, a standard for FAX), G4 (Group 4, a standard for FAX), or etc. is used as a communication protocol or a communication standard.

In the file sharing system FS, users can share files recorded in a hard disk in the image forming apparatus 1, by operating from the image forming apparatus 1 as well as respective PCs 31. Users may also use workstations, PDAs (Personal Digital Assistants), or cell-phone terminals, instead of the PCs 31.

The image forming apparatus 1 has a plurality of functions all in one, such as copying, network printing, scanning, a FAX, a document server, etc., and it is sometimes called also as a multifunctional machine or a MFP (Multi Function Peripheral).

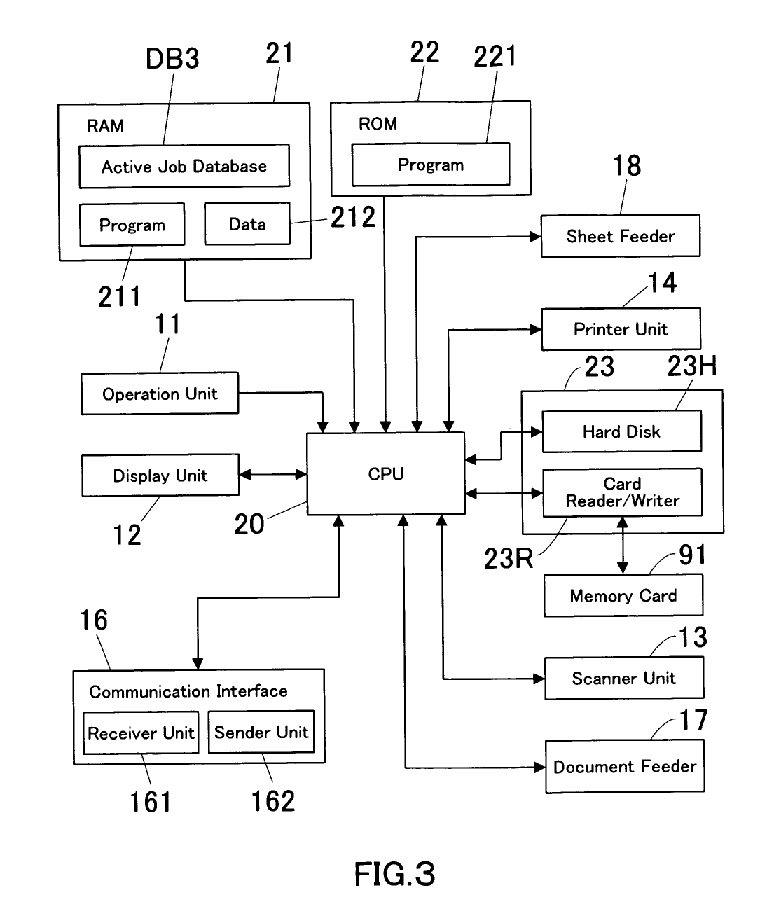

FIG. 2 and FIG. 3 are an external view of the image forming apparatus 1 and a hardware configuration of the image forming apparatus 1, respectively.

As shown in FIG. 2 and FIG. 3, the image forming apparatus 1 comprises an operation unit 11, a display unit 12, a scanner unit 13, a printer unit 14, a communication interface 16, a document feeder 17, a sheet feeder 18, a receiving tray 19, a CPU 20, a RAM 21, a ROM 22, a data recording unit 23 and others.

The operation unit 11 comprises a plurality of keys for inputting characters such as numbers, letters, marks and etc., a sensor for sensing pressed keys, a transmission circuit for transmitting to the CPU 20 signals indicating the sensed keys, and others.

The display unit 12 displays screens for letting users read messages or instructions, input instructions for setting and processing, confirm image formed and processing results drawn by the image forming apparatus 1, and etc.

In the present embodiment, a touch panel is used as the display unit 12. Therefore, the display unit 12 senses locations on the touch panel, where are touched by users with fingers, and then transmit to the CPU 20 signals indicating the sensing results.

In sum, the operation unit 11 and the display unit 12 function as user interfaces for letting users directly operate the image forming apparatus 1.

In addition, an application program and a driver for giving instructions against the image forming apparatus 1, are installed in the PC31. Thus, users can operate the image forming apparatus 1 remotely from the PC 31.

The scanner unit 13 photoelectrically reads image such as photos, characters, drawings, charts, etc. carried on a document, and then generates digital image data such as density data indicating color density of R (Red), G (Green), B (Blue) or K (Black). The digital image data obtained in this way above will be used for printing in the printer unit 14.

Meanwhile, the read data is recorded in the data recording unit 23 or transmitted to the PC 31 after being converted to data of a format such as TIFF (Tagged Image File Format), PDF (Portable Document Format), or etc. Otherwise, it is transmitted to the FAX terminal 32 after being converted to FAX data.

The document feeder 17 placed on the top of the main body of the image forming apparatus 1, sends to the scanner unit 13, one or more sheets of document, sequentially.

The printer unit 14 prints on a transfer sheet made of paper, film, or etc., the image read by the scanner unit 13, or image from the data transmitted from the PC 31 or the FAX data transmitted from the FAX terminal 32.

The sheet feeder 18 placed in the lower region of the main body of the image forming apparatus 1, provides the printer unit 14 with appropriate transfer sheets that fit to image to be printed. Then, the transfer sheets carrying the image printed by the printer unit 14, i.e. the printed paper, is discharged on the receiving tray 19.

The communication interface 16 comprising a sender unit, a receiver unit and others, exchanges data with the PC 31 and the FAX terminal 32. A NIC (Network Interface Card), a modem, a TA (Terminal Adapter), or etc. is used as the communication interface 16.

The data recording unit 23 comprises a hard disk 23H, a card reader/writer 23R and others.

The card reader/writer 23R reads and writes data from and in a memory card 91 such as a CompactFlash or a SmartMedia.

The memory card 91 is used to exchange data chiefly with the PC 31 without involving the communication line 4, or backup data.

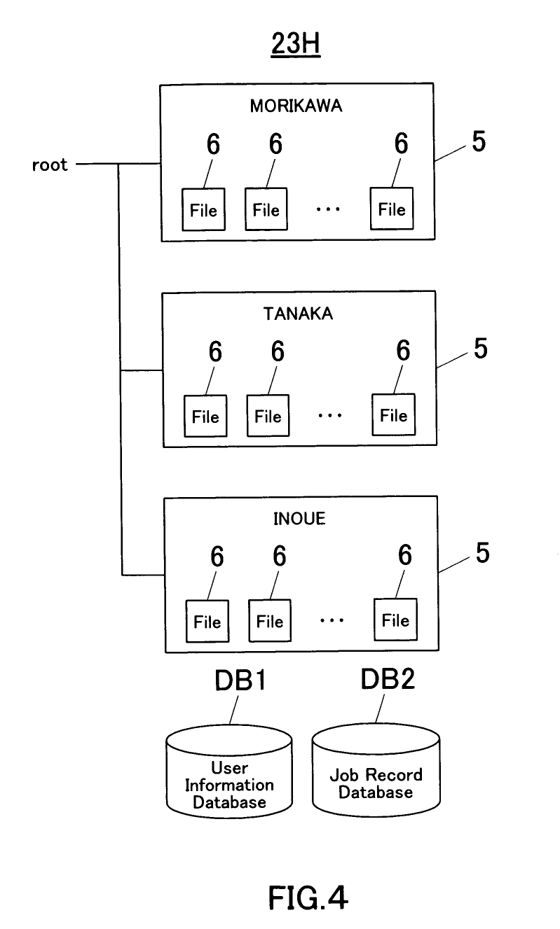

As shown in FIG. 4, in the hard disk 23H, memory areas that are personal boxes are allocated for respective users to store their own files as files 6. The personal box corresponds to a “directory” or a “holder” commonly used in the PCs 31, workstations or etc. Hereinafter, the personal box will be referred to as a “box 5”.

The box 5 has a box name to differentiate from other boxes 5. In the present embodiment, a user name of the owner of the box 5 is used as the box name of the box 5.

Users can record in the box 5 the file 6 shown in FIG. 4, by forwarding it from the PC 31, or by copying it from the memory card 91 inserted in slot of the card reader/writer 23R. In addition, the files 6 can also be recorded in the box 5 in the following cases.

For example, when a user gives an instruction to copy a document placed on the document feeder 17, image data read out from the document is converted to the file 6, and then the file 6 is stored in the box 5 of the user, by the image forming apparatus 1. Similarly, when a user gives an instruction to transmit image data of a document placed on the document feeder 17 to the PC 31, the image data read out from the document is converted to the file 6, and then the file 6 is stored in the box 5 of the user.

Further, when a user gives an instruction from the PC 31 to print (network-print) a document, image data of the document transmitted from the PC 31 is stored as the file 6 in the box 5 of the user.

And further, when FAX data is transmitted from the FAX terminal 32, the FAX data is stored as the file 6 in the box 5 of a user who is the recipient of the FAX data.

Still further, when a user gives an instruction to transmit image data of a document placed on the document feeder 17 to the FAX terminal 32, the image data read out from the document is converted to the file 6, and then the file 6 is stored in the box 5 of the user.

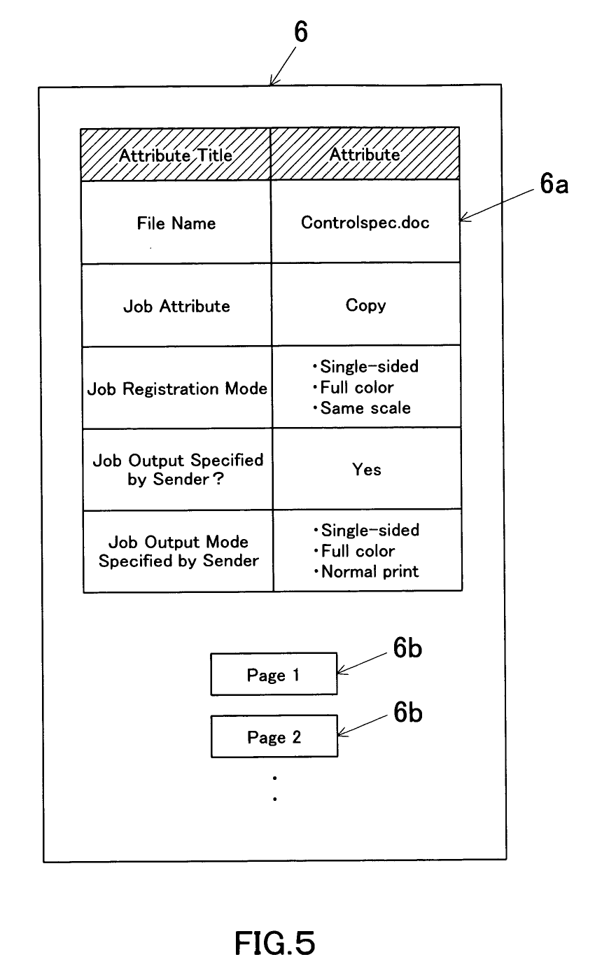

FIG. 5 is a diagram showing a specification of the file 6 to be stored in the box 5, and the file 6 comprises attribute information 6a, actual image data 6b and others.

The attribute information 6a shows attributes regarding the file 6, and the actual image data 6b means content data (image, text, figures, and etc.) of respective pages consisted of by a document that is the file 6.

“File name” in the attribute information 6a is identification information for differentiating the file 6 from the other files 6.

“Job attribute” means what process should be executed on the file 6. The value in job attribute is determined based on an instruction by user, and how the file 6 was stored in the box 5.

For example, FIG. 5 shows the value in job attribute is “copy”. This means the file 6, which is for copying a document, was generated by converting image data read out from the document according to a copy instruction by a user, then stored in the box 5.

Otherwise, the value in job attribute may be “scan” “print”, “FAX transmission”, “FAX reception”, and etc.

“Scan” means the file 6, which is for transmitting the image of a scanned document to the PC 31, was generated by converting image data read out from the document according to a scan instruction by a user, then stored in the box 5.

“Print” means the file 6, which is for printing image of a document, was prepared on the PC 31, then acquired from the PC 31 according to a print instruction by a user, and then stored in the box 5.

“FAX transmission” means the file 6, which is for transmitting image of a scanned document to the FAX terminal 32, was generated by converting to a FAX format file, the image data read out from the document according to a FAX transmit instruction by a user, then stored in the box 5.

“FAX reception” means the file 6, which is for printing image transmitted from the FAX terminal 32, was generated by converting FAX data of the received image, then stored in the box 5.

“Job registration mode” in the attribute information 6a means what conditions are inputted for the process shown in the “job attribute” field.

For example, as shown in FIG. 5, a document is scanned for copy with conditions “single-sided” as a scanning mode, “full color” as a color mode and “same scale” as a copy scale. In addition, other various conditions such as density and document size can be set as “job registration mode”.

As for the files 6 simply transferred from the PC 31 and copied from the memory card 91, it is noted that values are not set for the job attributes and the job registration modes like in the way above.

In addition, the hard disk 23H has a user information database DB1 and a job record database DB2.

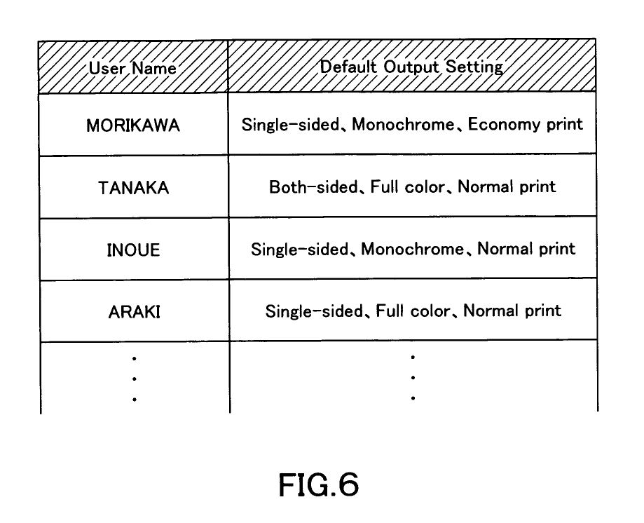

As shown in FIG. 6, in the user information database DB1, information about users who use the image forming apparatus 1 is registered.

“User name” is identification information for differentiating respective users, and is used as information of a box in which data is stored when a user uses the image forming apparatus 1, or of a destination when a user transmits image to other user.

In the user information database DB1, default output settings for respective users are registered, and the users can register their own preferable output settings. The default output settings are checked when a user transmits image data in his/her box to other users, and then the image data is transmitted with the default output settings.

As shown in FIG. 3, the ROM 22 records a program 221 and data for enabling basic functions of the image forming apparatus 1, such as image reading (scan), document copy (copy), FAX data communication, network-printing, document server (box function), and etc.

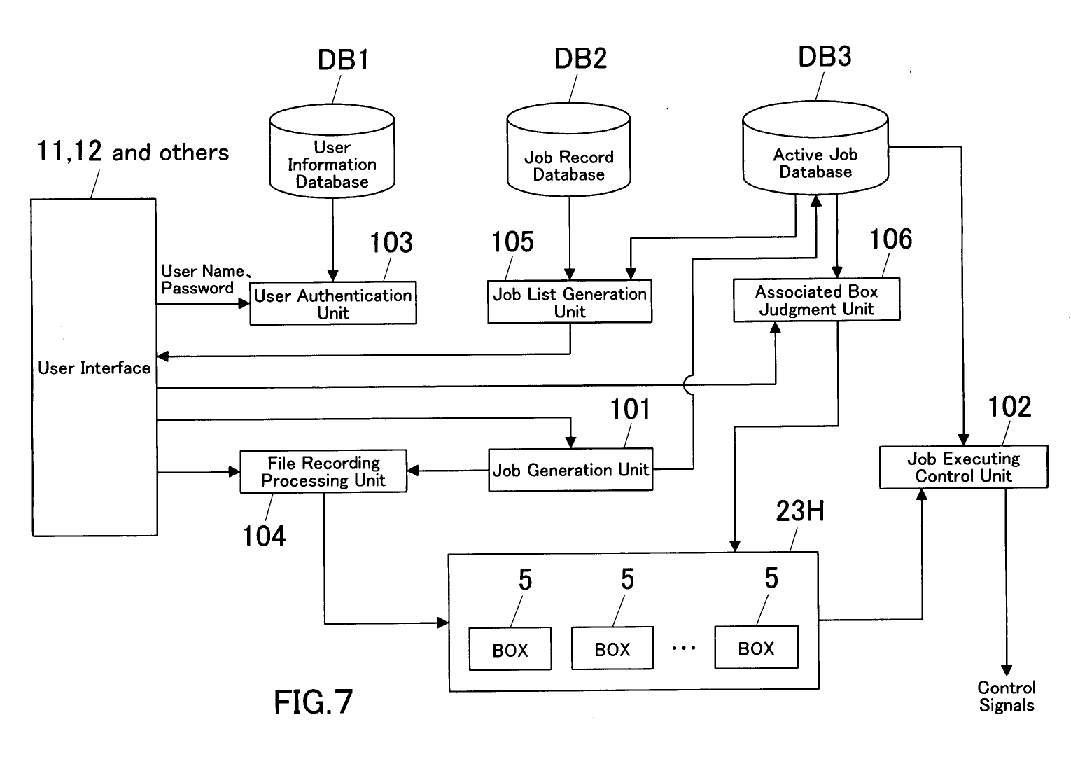

The ROM 22 further records a program 221 and data for enabling functions of a job generation unit 101, a job executing control unit 102, a user authentication unit 103, a file recording processing unit 104, a job list generation unit 105, an associated box judgment unit 106, that are shown in FIG. 7.

Only one or entire portion of the programs 221 and the data may be installed in the data recording unit 23. In this case, the programs 221 and the data installed in the data recording unit 23 are loaded into the RAM 21 if needed (programs 211 and data 212). Otherwise, only one or entire portion of the functions may be activated by a processor (a circuit).

The RAM 21 temporarily records data transmitted from the PC 31 or the FAX terminal 32, data to be transmitted to the PC 31 or the FAX terminal 32, data generated by the scanner unit 13, and others. A nonvolatile RAM may be used as the RAM 21.

Further, the RAM 21 records an active job database DB3, which stores information of waiting processings (obs), in other words, a job queue (queue). Each of the waiting jobs is associated with a file specification like shown in FIG. 5, and the jobs are processed in the order of registration, one by one.

The CPU 20 controls the entire image forming apparatus 1 by activating the program 221 recorded in the ROM 22 or the other program 211 loaded into the RAM 21

Subsequently, functions and processings of respective units in the image forming apparatus 1 will be explained as following with reference to FIG. 7.

As shown in FIG. 7, the job generation unit 101 executes processing for generating the file 6 out of image data obtained by scan processing by the scanner unit 13, print data transmitted from the PC 31, or print data transmitted from the FAX terminal 32. The file recording processing unit 104 executes processing for recording the generated file 6 in the predetermined box 5.

The job executing control unit 102 controls the respective units in the image forming apparatus 1 so that jobs are executed in the order of a queue in the active job database DB3.

The user authentication unit 103 performs the processes of user authentication administration, preview when image is forwarded, and reading out default output settings from the user information database DB1 shown in FIG. 6 when image is outputted.

The job list generation unit 105 generates a predetermined job list.

The associated box judgment unit 106 judges the box 5 that is associated with a job specified by a user.

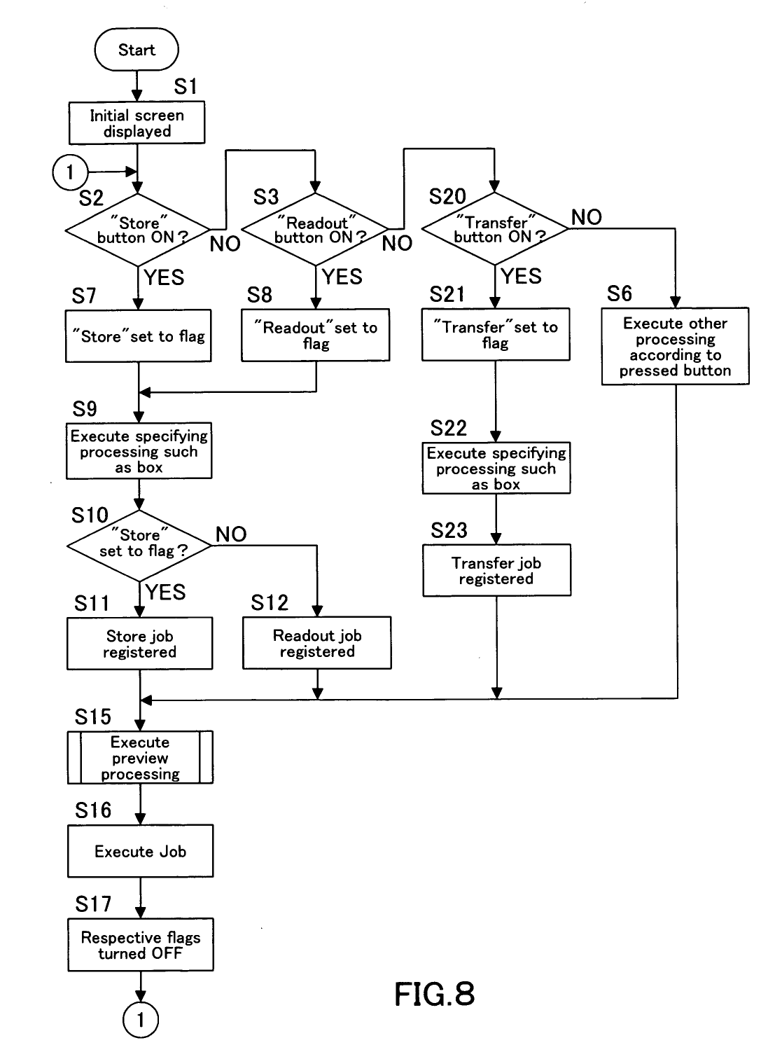

Subsequently, the entire process (including data storing in the box 5, printing of data read out from the box 5, data preview and forward, etc.) executed in the image forming apparatus 1, will be explained with reference to the flowchart in FIG. 8.

The programs for executing processings shown in respective flowcharts is recorded in the ROM 22, the hard disk 23H, or other, and each of the processings shown in the flowcharts is executed by the CPU 20, that controls the respective units in the image forming apparatus 1 according to the program.

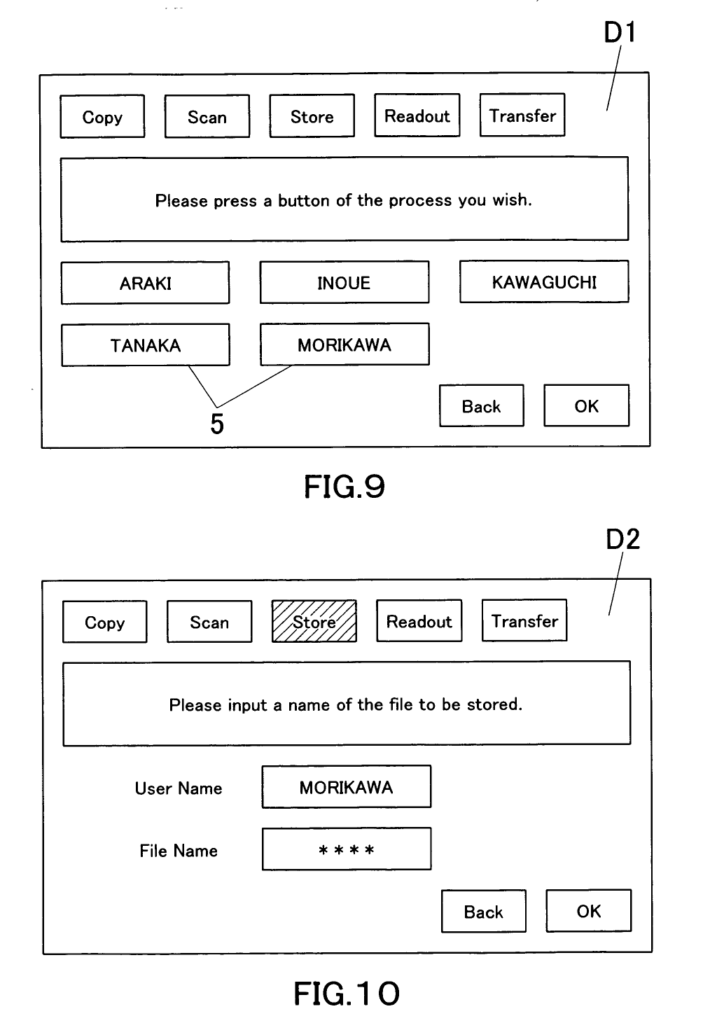

As shown in FIG. 8, as long as no user directly operates the image forming apparatus 1, an initial menu screen D1 as shown in FIG. 9 is displayed on the display unit 12 in Step S1.

A user, who is trying to make the image forming apparatus 1 execute processing, selects “copy” “scan”, “store”, “readout” or “forward” by pressing a button corresponding to the intended processing in the initial menu screen D1.

In Step S2, it is judged whether or not the “store” button is pressed in the initial menu screen D1. If the “store” button is pressed (YES in Step S2), “store” is set as a value of a flag, which indicates a condition (kind) of processing to be executed in Step S7. And then the routine proceeds to Step S9.

If the “store” button is not pressed (NO in Step S2), it is judged whether or not the “readout” button is pressed in Step S3. If the “readout” button is pressed (YES in Step S3), “readout” is set as a value of a flag in Step S8, and then the routine proceeds to Step S9.

In Step S9, an instruction by a user to specify a file to be stored and the box 5 as a storing destination is accepted. Otherwise, an instruction by a user to specify a file to be read out is accepted.

Subsequently, in Step S10, it is judged whether or not “store” is set to a flag. If “store” is set to a flag (YES in Step S10), in Step S11, a store job is registered in the active job database DB3 shown in FIG. 7, and then the routine proceeds to Step S15. The store job is a processing for storing into the box 5 selected by user in the screen D1 in FIG. 9, image data of a document scanned by the scanner unit 13, with a file name inputted in the screen D2 in FIG. 10.

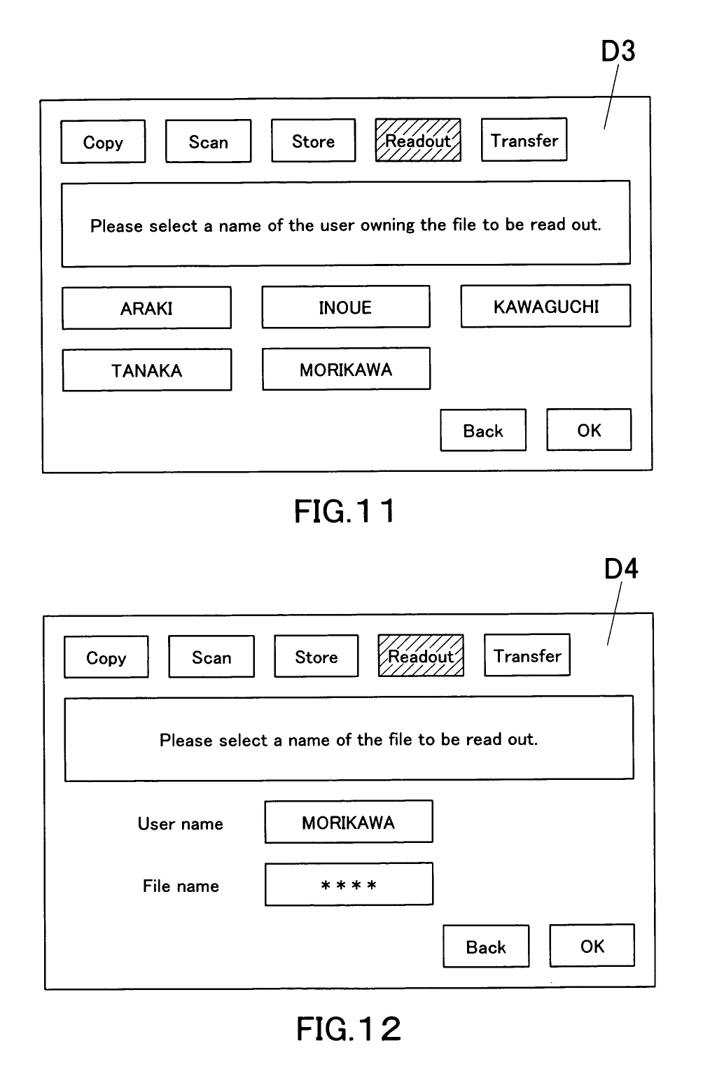

If “store” is not set to a flag (NO in Step S10), in Step S12, a readout job is registered in the active job database DB3 shown in FIG. 7, and then the routine proceeds to the Step S15. The readout job is a processing for reading out a file with a file name inputted in the screen D4 in FIG. 12 among the files stored in the box 5 that is selected by user in the screen D3 in FIG. 11, and printing by the printer unit 14.

If the “readout” button is not pressed (NO in Step S3), it is judged whether or not the “forward” button is pressed in Step S20. If the “forward” button is pressed (YES in Step S20), “forward” is set to a flag in Step S21.

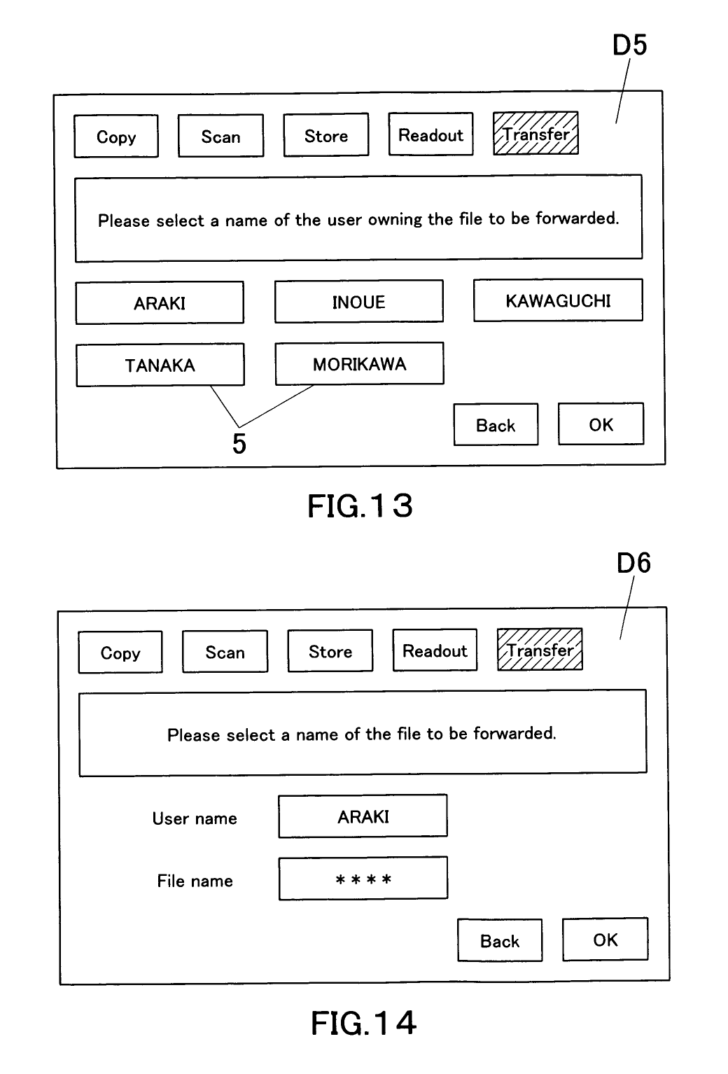

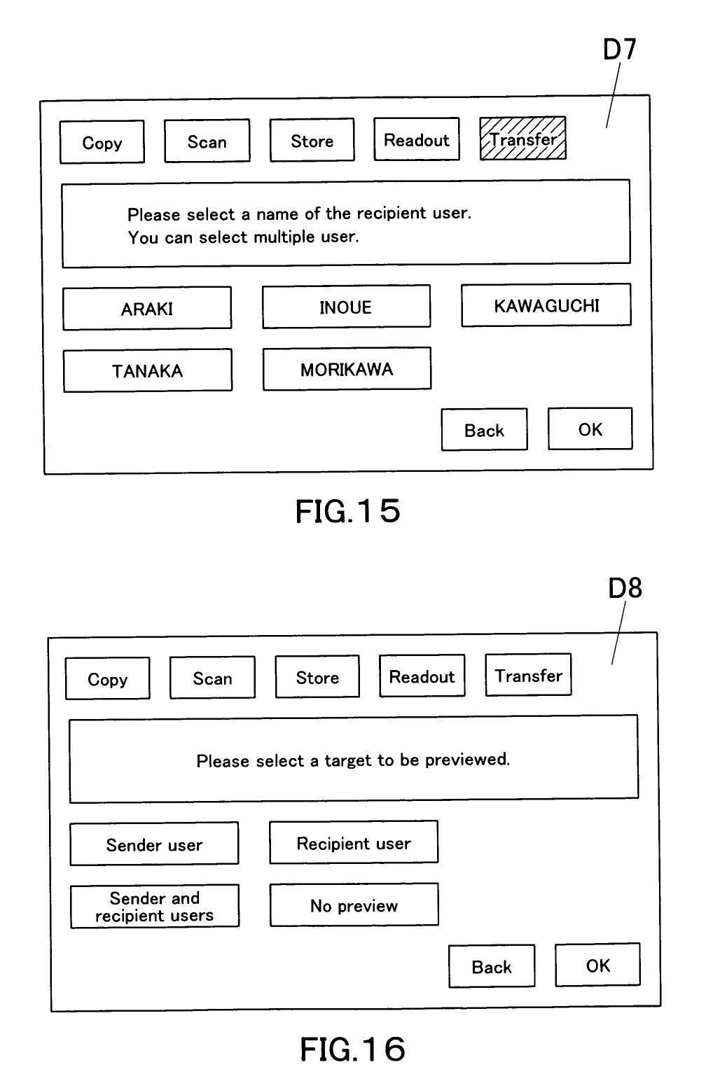

Then, in Step S22, instructions by a sender user to specify the originating box 5, a file to be forwarded and a recipient user as a forwarding destination are accepted. Then, in Step S23, a forward job is registered in the active job database DB3 shown in FIG. 7, and then the routine proceeds to Step S15. The forward job is a processing for reading out a file with a file name inputted in the screen D6 in FIG. 14 among the files stored in the box 5 that is selected by user in the screen D5 in FIG. 13, and transmitting the file to the forwarding destination (the recipient user) that is selected in the screen D7 in FIG. 15. In the present embodiment, a plurality of recipient users can be specified as forwarding destinations. For example, as shown in FIG. 15, a plurality of recipient users can be specified among “ARAKI”, “INOUE”, “KAWAGUTI”, “TANAKA” and “MORIKAWA”.

In addition, in the present embodiment, the file is forwarded with the default setting of the recipient user (shown in FIG. 6), unless the sender user changes the setting. This point will be explained below.

If a “back” button is pressed in the respective screens D1 in FIG. 9 to D7 in FIG. 15, the initial menu screen D1 will be redisplayed. Thus, users can undo the operations such as selecting a condition for each item.

Back in FIG. 8, if the “forward” button is not pressed (NO in Step S20), processing is executed according to the other pressed button in Step S6, and then the routine proceeds to Step S15.

To explain concretely, if the “copy” button or the “scan” button is pressed, another screen for specifying a process condition corresponding to the pressed button (hereinafter, referred to as “process condition specification screen”) is displayed to encourage a user to input the condition. Upon inputting the condition, the job generation unit 101 generates a job for processing according to the inputted condition, and then registers the job in the active job database DB3.

For example, if the “copy” button is pressed, the display unit 12 is controlled to display the process condition specification screen for specifying conditions, such as single-sided/both-sided and full color/monochrome. The job generation unit 101 generates a job for copy processing according to the specified conditions, and registers the job in the active job database DB3.

If the “scan” button is pressed, the process condition specification screen for specifying conditions regarding image quality, density and both-sided or not, when a document is scanned; file format (TIFF, PDF or etc.) when read image data is converted to a file; a destination of the converted file; and others is displayed. The job generation unit 101 generates a scan job for scan processing according to the specified conditions, and registers the job in the active job database DB3.

In the Step S15, preview processing is executed. This processing will be explained below.

Subsequently, the job executing control unit 102 executes processings on the jobs registered in the active job database DB3 in order. For example, when a store job is registered in Step S11, a document placed on the document feeder 17 is scanned. Then, not only image data of the scanned document is converted to the actual image data 6b (shown in FIG. 5) of a predetermined format, but also the attribute information 6a is generated according to the specified conditions. Then the file 6 is generated by grouping the attribute information 6a and actual image data 6b, and then the file 6 is stored in a specified box.

When a readout job is registered in Step S12, the printer 14 is controlled to read out a file from a specified box, and print it on a transfer sheet.

When a copy job is registered, the scanner unit 13 is controlled to scan a document placed on the document feeder 17, and then the printer unit 14 is controlled to print the image on a transfer sheet, according to the conditions specified by user. When a scan job is registered, the scanner unit 13 is controlled to scan a document placed on the document feeder 17, and then the attribute information 6a and the actual image data 6b of the scanned document are generated, then the file 6 is generated by grouping those. And the communication interface 16 is controlled to transmit the file 6 to the specified destination.

When a transfer job is registered, the communication interface 16 and others are controlled to transmit a specified file to a specified recipient user.

Proceeding to Step S17, the respective flags of “store” “readout” and “transfer” are turned off and the process returns to Step S2.

Meanwhile, users can make the image forming apparatus 1 to execute print processing by remotely operating from the PC 31. For example, a user preliminarily opens a file of image to be printed, and then specifies print conditions and inputs a predetermined command. Then, print data of the image is transmitted together with information of the specified print conditions, to the image forming apparatus 1 from the PC31.

If the data is received by the image forming apparatus 1, a print job is registered in the active job database DB3 (shown in FIG. 7) and the printer unit 14 and others are made to execute print processing on the job when its turn comes, like in the same way as the copy job described above.

In addition, users can store in their own boxes 5, the file 6 for printing by the image forming apparatus 1, image created on the PC31. In this case, a user selects an option corresponding to the “store” button of the initial menu screen before inputting a command for print processing. Then, the file recording processing unit 104 generates the file 6 out of print data and others transferred from the PC31, and then stores the file 6 into the box 5 of the user.

Users log out the image forming apparatus 1 by a predetermined operation when they finish using the image forming apparatus 1. Otherwise, they may be forcibly logged out if a non-operation state continues for a predetermined period of time.

Meanwhile, the image forming apparatus 1 has an installed program for transmitting to the PC 31, screen data of respective screens that are equals to those displayed on the display unit 12, as well as another installed program for receiving information inputted from the respective screens from the PC 31. Thus, users can read out the file 6 stored in the box 5 and make the image forming apparatus 1 to execute intended processings, remotely from their own PCs 31.

Hereinafter, a preview processing shown in Step S15 in FIG. 8 will be explained. The preview processing is executed to preview at least one of output settings for a sender user and a recipient user among the default output settings for respective users shown in FIG. 6, if “transfer” is set to a flag in Step S21 in FIG. 8, in other words, if a transfer job is registered. Thus, the sender user can easily check the output settings for the sender user himself/herself and the recipient user. In the way as described above, when a sender user prefers a recipient user to output data according to the output setting for the sender user himself/herself, the sender user can easily check whether or not the output settings for the recipient user and the sender user himself/herself are exactly the same.

In the present embodiment, it is possible to configure preliminarily which is (are) to be previewed, among the output settings for the sender user and the recipient user.

FIG. 16 shows the selection screen D8 for configuring the setting. A “sender user” button for previewing the output setting for the sender user, a “recipient user” button for previewing the output setting for the recipient user, a “sender and recipient users” button for previewing the output settings both for the sender user and the recipient user, and a “no preview” button for not previewing any output setting both for the sender user and the recipient user, are displayed in the selection screen D8. Thus, the output setting only for the sender user, the output setting only for the recipient user, or the output settings both for them can be previewed, by selecting a button among the buttons in the screen D8. Otherwise, users can prohibit previewing (doesn't preview).

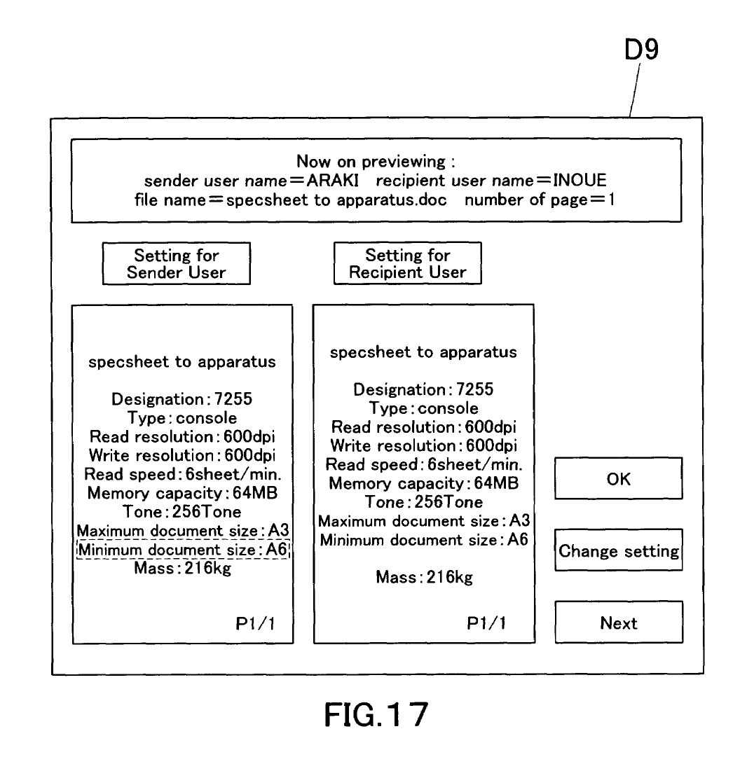

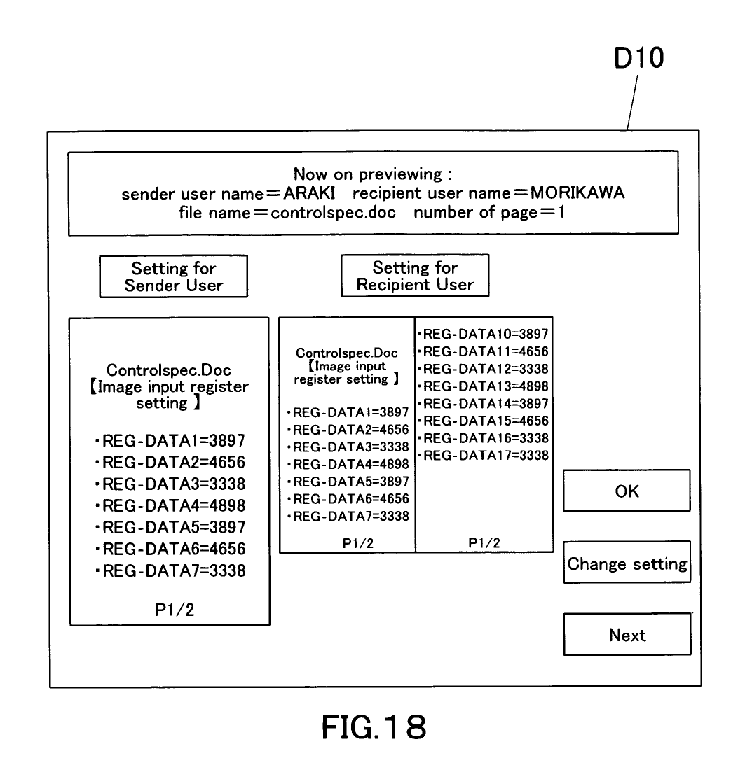

FIG. 17 and FIG. 18 show examples of the preview screens D9 and D10, respectively. In the present embodiment, it is assumed that the “sender and recipient users” button is selected in FIG. 16.

In the example shown in the preview screen D9 in FIG. 17, the sender user name is ARAKI, the recipient user name is INOUE, the output setting for the sender user is full color and normal print mode, and the output setting for the recipient user is monochrome and normal print mode (respectively according to the user information database FIG. 6).

In each of the fields of the sender user and the recipient user, the same file content is displayed except for one portion “minimum document size: A6” (the portion enclosed by dotted line in FIG. 17), that is displayed practically in color in the field of the sender user. This indicates the output setting for the sender user is color mode.

On the other hand, there is no portion displayed in color in the field of the recipient user, and this means output is done in a monochrome mode.

As described above in the present embodiment, unless the sender user specifies, data is transmitted with the output setting for the recipient user. However, there is a “change setting” button prepared in the screen D9, as a method for the sender user to change it to the same output setting for the sender user himself/herself. By pressing the “change setting” button, the output setting is changed to that for the sender user. Then a data file is forwarded with the changed output setting.

In the example shown in the preview screen D10 in FIG. 18, the sender user name is ARAKI, the recipient user name is MORIKAWA, the output setting for the sender user is monochrome and normal print mode, and the output setting for the recipient user is monochrome and economy print mode (a 2-in-1 mode for printing two pages of into one transfer sheet). In the field of the recipient user, data are displayed in a two-page spread, and this indicates the output setting for the recipient user is economy print mode.

There is the “change setting” button prepared also in the screen D10 in FIG. 18. In addition, in FIG. 17 and FIG. 18, there are an “OK” button for determining the entry, and a “next” button for switching the preview screen to that for a next user if a plurality of recipient users are selected.

In this way as described above, the operations of confirming and changing output settings can be performed easily by displaying the output settings for a sender user and a recipient user side by side in one screen. Also, a sender user and a recipient user can be identified to change the output settings individually.

In the example shown in FIG. 17 and FIG. 18, the file contents reflecting the output setting are displayed, otherwise, the output settings may be displayed with text or marks.

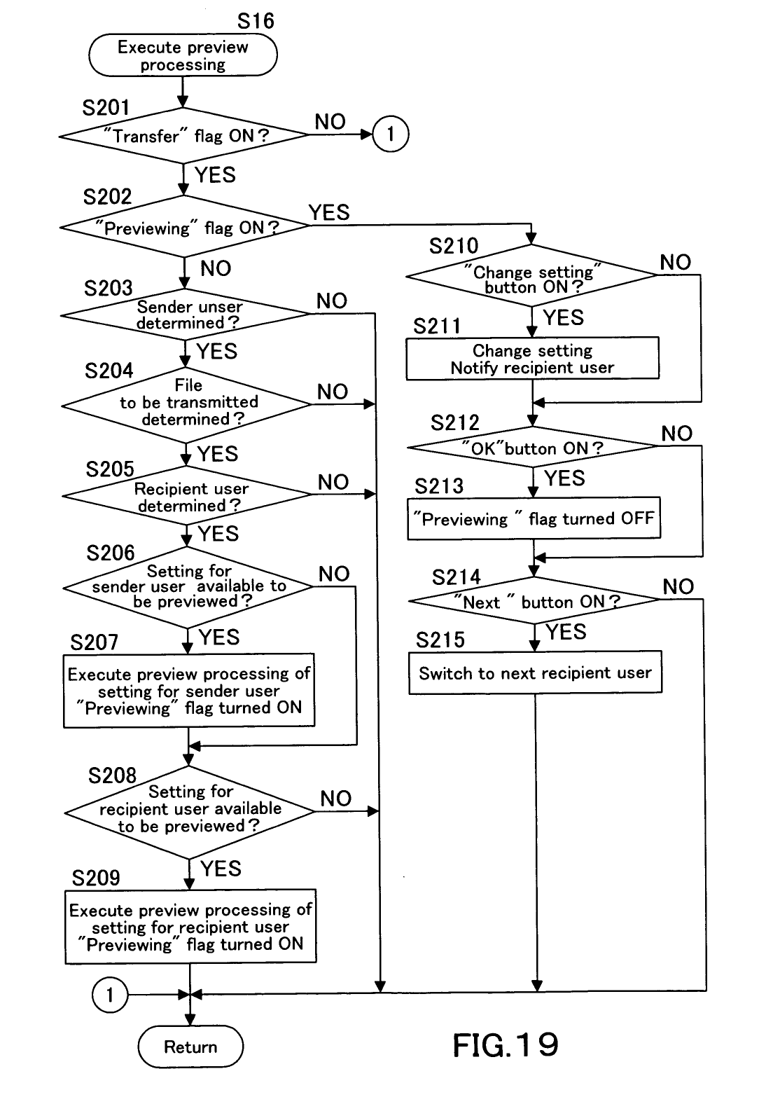

FIG. 19 is a flowchart showing a subroutine for the preview process in Step S15 in FIG. 8.

In Step S201 in FIG. 19, it is judged whether or not “transfer” is set to a flag. If “transfer” is not set to a flag (NO in Step S201), the routine directly returns without executing preview processing. Thus, the preview process is not executed on a file storing job, a copy job and a scan job.

If “transfer” is set to a flag (YES in Step S201), then it is judged whether or not a “previewing” flag is ON in Step S202. If a “previewing” flag is not ON (NO in Step S202), the routine proceeds to Step S203, and if a “previewing” flag is ON (YES in Step S202), the routine proceeds to Step S210.

In Step S203, it is judged whether or not a sender user is decided. If a sender user is decided (YES in Step S203), the routine proceeds to Step S204, and if a sender user is not decided (NO in Step S203), the routine directly returns.

In Step S204, it is judged whether or not a file to be transmitted is decided. If a file to be transmitted is decided (YES in Step S204), the routine proceeds to Step S205, and if a file to be transmitted is not decided (NO in Step S204), the routine directly returns.

In Step S205, it is judged whether or not a recipient user is decided. If a recipient user is decided (YES in Step S205), the routine proceeds to Step S206, and if a recipient user is not decided (NO in Step S206), the routine directly returns.

In Step S206, it is judged whether or not a preview setting for previewing the output setting for the sender user is configured, i.e. the output setting for the sender user is available to be previewed. If the output setting for the sender user is available to be previewed (YES in Step S206), not only the output setting for the sender user is previewed but also the “previewing” flag is turned ON in Step S207, and then the routine proceeds to Step S208. If the output setting for the sender user is not available to be previewed (NO in Step S206), the routine proceeds directly to Step S208.

In Step S208, it is judged whether or not a preview setting for previewing the output setting for the recipient user is configured, i.e. the output setting for the recipient user is available to be previewed. If the output setting for the recipient user is available to be previewed (YES in Step S208), not only the output setting for the recipient user is previewed but also the “previewing” flag is turned ON in Step S209, and then the process returns. If the output setting for the recipient user is not available to be previewed (NO in Step S208), the routine directly returns.

If the preview settings for previewing the output settings both for the sender user and the recipient user are configured, the routine proceeds following the arrows YES in Step S206 and in Step S208 as well, and the output settings both for them are previewed.

Meanwhile, in Step S210, it is judged whether or not the “change setting” button shown in FIG. 17 or FIG. 18 is pressed. If the “change setting” button is pressed (YES in Step S210), the output setting for the recipient user is changed to that for the sender user regarding a file to be transmitted and then it is notified to the recipient user that the output setting for the sender user himself/herself is available, in Step S211. And then, the routine proceeds to Step S212. If the “change setting” is not pressed (NO in Step S210), the routine proceeds directly to Step S212.

Thanks to the notice, the recipient user recognizes the file is transferred with the output setting for the sender user. Thus, image data or others can be outputted exactly in the way that the sender user intended.

In Step S212, it is judged whether or not the “OK” button in FIG. 17 or FIG. 18 is pressed. If the “OK” button is pressed (YES in Step S212), the “previewing” flag is tuned OFF in Step S213, and then the routine proceeds to Step S214. If the “OK” button is not pressed (NO in Step S212), the routine proceeds directly to Step S214.

In Step S214, it is judged whether or not the “next” button in FIG. 17 or FIG. 18 is pressed. If the “next” button is pressed (YES in Step S214), then in Step S215, it is judged whether or not a plurality of recipient users are set for multi-address transmission to switch to another change setting for a next recipient user, and then the routine directly returns. If the “next” button is not pressed (NO in Step S214), the routine directly returns.

Therefore, if a plurality of recipient users are set as destinations, the “previewing” flag is kept ON by pressing the “next” button in Step S214 without pressing the “OK” button in Step S212. In this way, it will be judged YES in Step S202 in the next routine, and then the output setting for each recipient user can be confirmed in the preview screen shown in FIG. 17 or FIG. 18 and can be changed (Step S210) if needed.

After previewing the output settings for all the recipient users, if the “OK” button is pressed (YES in Step S212), the “previewing” flag and the “transfer” flag are turned OFF in Step S213 and S214, respectively. Then, if the “next” button is not pressed (NO in Step S214), a transfer job is finally determined and registered.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions present in that limitation: a) “means for“or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A data transmission apparatus, comprising:
a recording unit for recording data output settings for respective users preliminarily;
a communication unit for transmitting to a recipient user target data with the output setting either for a sender user or the recipient user, which is recorded in said recording unit, according to an instruction by the sender user; and
a display unit for previewing at least one of output settings for the sender user and the recipient user among those recorded in said recording unit, before transmitting said data.

2. The data transmission apparatus as recited in claim 1, further comprising an operation unit for changing the output setting regarding said data to be transferred.

3. The data transmission apparatus as recited in claim 1, comprising a notifying unit for notifying the recipient user if the output setting regarding said data to be transferred is changed.

4. The data transmission apparatus as recited in claim 1, wherein said display unit is capable of previewing the output settings for all the recipient users if data is transmitted to a plurality of users.

5. The data transmission apparatus as recited in claim 1, further comprising a setting unit for setting the sender user or the recipient user for whose output setting is to be previewed.

6. A data transmission method, comprising the steps of:
transmitting to a recipient user target data with the output setting either for a sender user or the recipient user, which is recorded in said recording unit, according to an instruction by the sender user; and
previewing at least one of output settings for the sender user and the recipient user among those recorded in said recording unit, before transmitting said data.

7. The data transmission method as recited in claim 6, further comprising the step of changing the output setting regarding said data to be transferred.

8. The data transmission method as recited in claim 6, wherein a notice is sent to the recipient user if the output setting regarding said data to be transferred is changed.

9. The data transmission method as recited in claim 6, wherein said display unit previews the output settings for all the recipient users if data is transmitted to a plurality of users.

10. The data transmission method as recited in claim 6, further comprising the step of setting the sender user or the recipient user for whose output setting is to be previewed.

11. A recording medium recording a data transmission processing program for making a computer execute the steps of:
transmitting to a recipient user target data with the output setting either for a sender user or the recipient user, which is recorded in said recording unit, according to an instruction by the sender user; and
previewing at least one of output settings for the sender user and the recipient user among those recorded in said recording unit, before transmitting said data.

12. The recording medium as recited in claim 11, wherein said program further makes a computer execute the step of changing the output setting regarding said data to be transferred.

13. The recording medium as recited in claim 11, wherein said program makes a computer execute the step of notifying the recipient user if the output setting regarding said data to be transferred is changed.

14. The recording medium as recited in claim 11, wherein said program makes a computer execute the step of previewing the output settings for all the recipient users on said display unit if data is transmitted to a plurality of users.

15. The recording medium as recited in claim 11, wherein said program makes a computer execute the step of setting the sender user or the recipient user for whose output setting is to be previewed.
